(19) United States
(12) Patent Application Publication
(10) Pub. No.: US 2006/0209556 A1
(43) Pub. Date: Sep. 21, 2006

(54) Vehicle lamp

(75) Inventors: Takehiko Tajima, Shizuoka (JP); Masahito Naganawa, Shizuoka (JP); Kenichi Takada, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: KOITO MANUFACTURING CO., LTD.

(21) Appl. No.: 11/375,248

(22) Filed: Mar. 15, 2006

(30) Foreign Application Priority Data
Mar. 15, 2005 (JP) P.2005-073301
Mar. 15, 2005 (JP) P.2005-073302

(51) Int. Cl. F21V 7/00

(52) U.S. Cl. 362/516; 362/509

(57) ABSTRACT

An bending lamp is provided with, within a lamp room composed of a lamp body and a cover, a light source bulb equipped with a light source for emitting light; a reflector for reflecting light emitted from said light source; and a projection lens for directly forward projecting the light emitted from said light source. The reflector projects the light emitted from the light source directly outward of the vehicle. The optical axis of the group of light rays directly projected through the projection lens and the optical axis of the group of light rays projected through the reflector are oriented in independent directions.

The present application claims foreign priority based on a Japanese Patent Application No. P.2005-073301, filed on Mar. 15, 2005 and a Japanese Patent Application No. P.2005-073302, filed on Mar. 15, 2005, the contents of them are incorporated herein by reference.

### BACKGROUND OF THE INVENTION

1. Field of the Invention

The present invention relates to a vehicle lamp and more particularly to a vehicle lamp used as an identification lamp such as a bending lamp.

2. Related Art

In a front portion of a vehicle, a head lamp, a bending lamp or a plurality of identification lamps may be provided. The head lamp projects light mainly in a vehicle advancing direction. The plurality of identification lamps may include a turn signal lamp or stop lamp for indicating the presence of the vehicle or a driver's will for a third person outside the vehicle.

The bending lamp which is one of vehicle lamps is a lamp for improving a sideway visibility during cornering. The bending lamp generally adopts a “step reflector” which forms a free reflecting curve by a plurality of reflecting surface elements on a reflecting surface. The light emitted from a light source bulb is incident on this step reflector. The light reflected by each of the reflecting surface elements of the step reflector is projected to illuminate the areas in the front, rear and side of the vehicle (see for example, JP-A-10-162606).

Incidentally, if the step reflector is employed, the cover for covering the front of a lamp room is not required to have optical lens elements for e.g. diffusion or refraction but has only to pass light directly. Therefore, use of the step reflector provides an advantage in design giving an impression of transparency to the outer appearance of the entire lamp.

On the other hand, in the field of an illuminating lamp, in recent years, as the case may be, a projector-type illuminating device has been employed. The projector-type illuminating device is provided with a convex lens and a shade for making a distributed light pattern of a passing beam (lower beam) located in the vicinity of the focal point of the convex lens. The distributed light pattern formed by the shade is expanded by the convex lens and thereafter projected. Where the projector-type illumination device is employed, a cut-off line can be made clearly and freely and glare can be suppressed even using a light source with a large quantity of light. Further, the projector type illumination device, which can downsize the entire head lamp, can easily deal with various demands in design.

Generally, owing to limitation in design, the head lamp such as the bending lamp can be arranged in only an installing space smaller than the illumination lamp such as the head lamp. Therefore, where the projector type illuminating device is employed as the head lamp such as the bending lamp, a small-sized projector type illuminating device must be further downsized.

The projector type illuminating device projects light forward as substantially parallel rays of light through a lens. So the directivity of the rays of light is so high that in structure, the angular range of light projection in a vehicle width direction becomes narrow. Therefore, in order to apply this projector type illuminating device to the head lamp such as the bending lamp, any measure for increasing the angular range of light projection must be taken.

### SUMMARY OF THE INVENTION

One or more embodiments of the present invention provide a vehicle lamp which is small in size, gives a wide angular range of light projection and can be applied to a head lamp such as the bending lamp.

In accordance with one or more embodiments of the present invention, a vehicle lamp is provided with: a bulb including a light source for emitting light; a reflector that reflects the light emitted from the light source, wherein the light is reflected on the reflector toward an outside of a lamp room; and a projection lens that forward projects the light emitted directly from the light source. In the vehicle lamp, an optical axis of the light projected through the projection lens is oriented in a different direction from an optical axis of the light projected through the reflector.

According to the vehicle lamp, since the optical axis of the light directly projected through the projection lens, the optical axis of the light reflected on the reflector are different from one another, the light is projected over a wide angular range. Thus, the vehicle lamp with high visibility in forward, aslant-forward and sideward directions can be provided. Further, in accordance with this invention, the light emitted from the light source is directly projected through the projection lens. Therefore in the projector type illuminating device having a configuration in which the distance between the light source and the projection lens is short, intense spot-like light can be projected in a specific area. Accordingly, a vehicle lamp which is bright although its entire length is short can be obtained.

Further, in accordance with one or more embodiments of the present invention, the bulb may be arranged along a vehicle width direction.

For this reason, it does not occur that an attaching member for the light source bulb is provided on the side or rear subjected to considerable limitation in size and the end of the light source bulb is protruded. Thus, the vehicle lamp with an elegant layout can be provided.

Further, in accordance with one or more embodiments of the present invention, the optical axis of the light projected through the projection lens may be oriented at an angle of 10° to 20° from a vehicle longitudinal direction. In addition, the light reflected through the reflector may comprise diffused light diffused by an angle of 4° to 80° from a vehicle longitudinal direction.

According to the vehicle lamp, the angle formed by the optical axis of the light directly projected by the projection lens with the vehicle longitudinal direction is smaller than the angle of the light reflected on the reflector. Thus, since the optical axes of two kinds of light are different from one another, the vehicle lamp with high visibility in all of forward, aslant-forward and sideward directions can be provided. The light which is emitted from the light source and directly projected through the projection lens is projected at an angle nearest to the vehicle longitudinal direction and gives intense spot-like light in a specific area. Thus, while the vehicle runs at a medium speed, the light can be projected at a projecting angle effective to enhance the visibility of the vehicle lamp from forward. Accordingly, the vehicle lamp with further improved visibility during running can be provided.

Moreover, in accordance with one or more embodiments of the present invention, a vehicle lamp is provided with: a bulb including a light source for emitting light; a reflector that reflects the light emitted from the light source; and a projection lens that forward projects the light. In the vehicle lamp, the reflector includes: a first reflecting member, wherein the light emitted from the light source is reflected on the first reflecting member toward the projection lens; and

a second reflecting member, wherein the light emitted from the light source is reflected on the second reflecting member directly toward a sideward direction without being incident to the projection lens. In the vehicle lamp, first, second and third optical axes are different from one another, wherein the first optical axis is an optical axis of the light being directly incident to the projection lens from the light source and projected through the projection lens, the second optical axis is an optical axis of the light from first reflecting member and projected through the projection lens, and the third optical axis is an optical axis of the light reflected on the second reflecting member.

According to the vehicle lamp, since the optical axis of the light directly projected through the projection lens, the optical axis of the light projected through the first reflecting member and the optical axis of the light projected through the second reflecting member are different from one another, the light is projected over a wide angular range. Thus, the vehicle lamp with high visibility in forward, aslant-forward and sideward directions can be provided. Further, in accordance with this invention, since the light emitted from the light source is directly projected through the projection lens, in the projector type illuminating device having a configuration in which the distance between the light source and the projection lens is short, intense spot-like light can be projected in a specific area. Accordingly, a vehicle lamp which is bright although its entire length is short can be provided.

Further, in accordance with one or more embodiments of the present invention, the vehicle lamp may be further provided with: a shade arranged in a vicinity of a rear focal point of the projection lens, for shielding a part of the light reflected by the reflector; and a shielding member arranged on the light source bulb, for shielding a part of the light emitted from the light source.

According to the vehicle lamp, since the shade and the shielding member are located in the vicinity of the rear focal point of the projection lens, in both cases where the light from the light source is directly forward projected without being incident on the projection lens, and is projected forward through the first reflecting member constructed as an elliptical reflecting member, the light suitably shielded by the shielding member or the shade is incident on the projection lens. Thus, the light emitted from the projection lens is projected below e.g. a certain cut-off line, thereby giving no fear of glare. Accordingly, a suitable vehicle lamp which satisfies the standard for light distribution can be provided.

Further, in accordance with one or more embodiments of the present invention, the light source bulb may be arranged substantially in parallel to a vehicle vertical direction.

According to the vehicle lamp, the light source bulb is arranged upward from below substantially in parallel to the vehicle vertical direction. For this reason, it does not occur that an attaching member for the light source bulb is provided on the side or rear subjected to considerable limitation in size and the end of the light source bulb is protruded. Thus, the vehicle lamp with an elegant layout can be provided.

Further, in accordance with one or more embodiments of the present invention, an angle between the first optical axis and a vehicle longitudinal direction may be smaller than an angle between the second optical axis and the vehicle longitudinal direction, and may be smaller than an angle between the third optical axis and the vehicle longitudinal direction.

According to the vehicle lamp, the angle formed by the optical axis of the light directly projected by the projection lens with the vehicle longitudinal direction is smaller than the angle formed by the optical axis of the light projected through the first reflecting member with the vehicle longitudinal direction and the angle formed by the optical axis of the light projected through the second reflecting member with the vehicle longitudinal direction. Thus, since the optical axes of three kinds of light are different from one another, the vehicle lamp with high visibility in, all of forward, aslant-forward and sideward directions can be provided. The light which is emitted from the light source and directly projected through the projection lens is projected at an angle nearest to the vehicle longitudinal direction and gives intense spot-like light in a specific area. Thus, while the vehicle runs at a medium speed, the light can be projected at a projecting angle effective to enhance the forward visibility. Accordingly, the vehicle lamp with further improved forward visibility can be provided.

Further, in accordance with one or more embodiments of the present invention, an angle between the first optical axis and a vehicle longitudinal direction is in a range from 10° to 20°.

Other aspects and advantages of the invention will be apparent from the following description and the appended claims.

### BRIEF DESCRIPTION OF THE DRAWINGS

FIG. 1 is a horizontal sectional view of a lamp unit attached to a front right side of a vehicle.

FIG. 2 is an enlarged horizontal sectional view showing the details of only a bending lamp portion of the lamp unit in FIG. 1.

FIG. 3 is an optical path diagram of the light emitted from the bending lamp according to this embodiment.

FIG. 4 is a view showing the distributed light pattern of the light projected by the bending lamp.

FIG. 5 is a horizontal sectional view of a lamp unit attached to the front right side of a vehicle.

FIG. 6 is an enlarged horizontal sectional view showing the details of only a bending lamp portion of the lamp unit in FIG. 5.

FIG. 7 is a sectional view taken in line VII-VII in FIG. 6.

FIG. 8 is a sectional view taken in line VIII-VIII in FIG. 6.

FIG. 9 is an optical path diagram of the light emitted from the bending lamp according to this embodiment.

FIG. 10 is a view showing the distributed light pattern of the light projected by the bending lamp.

FIG. 11 shows another distributed light pattern of the light projected by the bending lamp.

### DETAILED DESCRIPTION OF THE EXEMPLARY EMBODIMENTS

Exemplary embodiments of the invention will be described with reference to the accompanying drawings.

<First Exemplary Emodiment>

An explanation will be given taking a bending lamp as an example of the vehicle lamp.

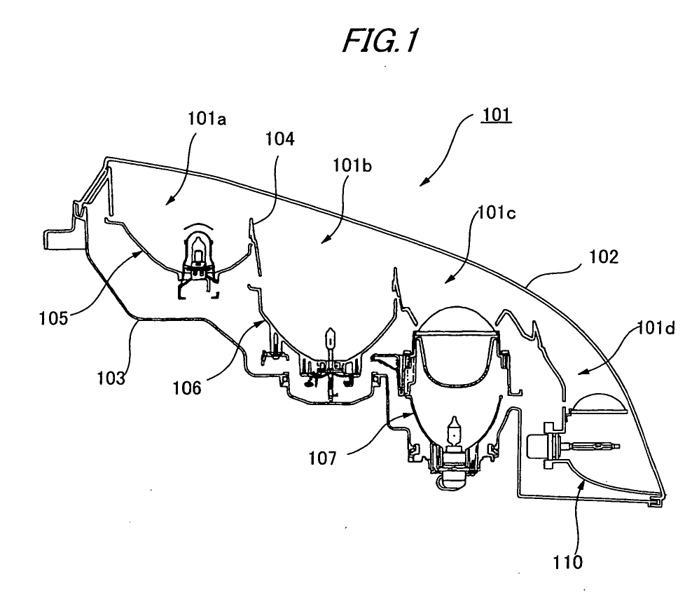

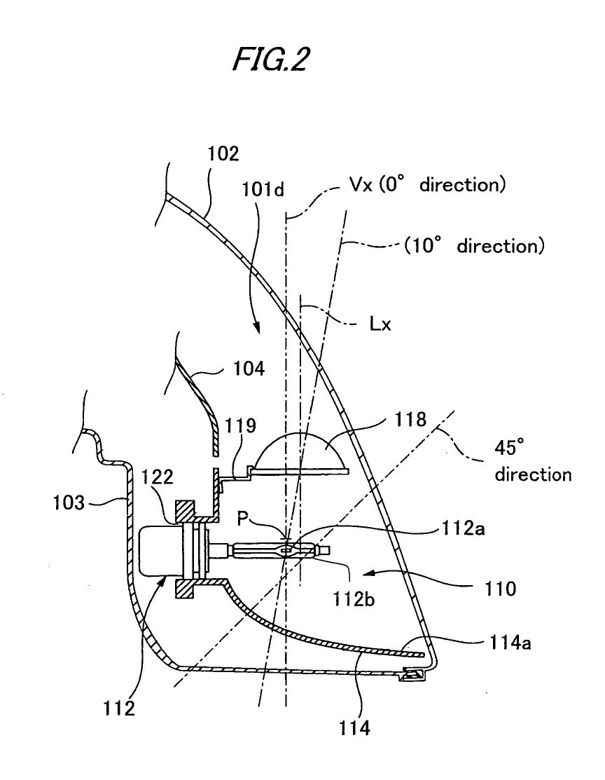

FIG. 1 is a horizontal sectional view of a lamp unit attached to the front right side of a vehicle. FIG. 2 is an enlarged horizontal sectional view showing the details of only a bending lamp portion of the lamp unit in FIG. 1.

As seen from FIG. 1, a lamp unit 101 according to this embodiment mainly includes a lamp body 103 and a light-permeable cover 102 covering the opening of the lamp body 103. The space between the lamp body 103 and the cover 102 is partitioned by extensions 104 to form four lamp rooms 101a, 101b, 101c and 101d. Each lamp room 101a, 101b, 101c, 101d incorporates a light source bulb, a reflector, etc to constitute a vehicle lamp.

In this embodiment, the lamp room 101a includes a fog lamp 105; the lamp room 101b includes a head lamp unit 106 for projecting a running beam (high beam); the lamp room 1c includes a head lamp unit 107 for projecting a “passing-each-other” beam (low beam); and the lamp room 101d includes a bending lamp 110.

A detailed explanation will be given of the bending lamp 110 provided in the lamp room 101d.

The bending lamp 110 is a head lamp which is attached to the front right side of the vehicle and lights up at the time of turning right according to a driver's operation, thereby assuring the visibility at the time of intersection cornering. The bending lamp 110, as seen from FIG. 2, includes a light source bulb 112; a reflector 114 so as to cover the light source bulb 112; and a projection lens 118 provided in front of the light source bulb 112.

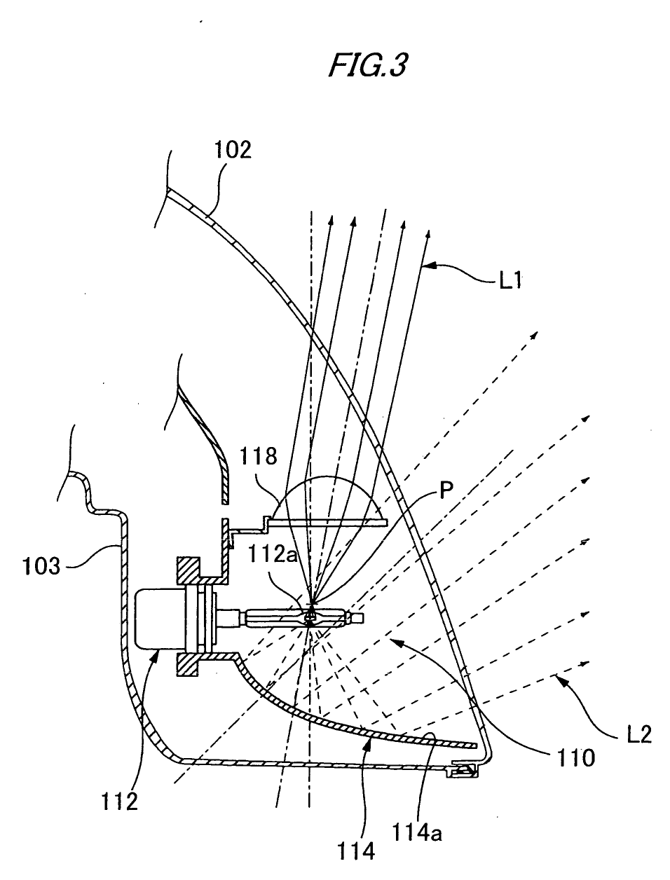

The light source bulb 112 is a halogen bulb such as H7, HB4 and H11, or a discharge bulb such as D2R. In FIG. 3, the discharge bulb is illustrated which emits light from a light source 112a constructed of a discharging portion within a bulb tube 112b. The light source bulb 112 is firmly inserted vehicle-widthwise from the side of reflector 114 into a through-hole 122 which opens vehicle-widthwise of the reflector 114. Thus, the light source bulb 112 is fixed so that the axial direction of the bulb tube 112b is substantially in parallel to the width direction of the vehicle and the light source 112a is located in the vicinity of P which is one point of a group of rear focal points of the projection lens 118.

The reflector 114 has a reflecting surface 114a formed on its inner periphery, which has e.g. a parabolic shape in its vertical section and a free curve formed to diffuse light in its horizontal section, as seen from FIG. 2. The focal point of the reflecting surface 114a is located substantially at the light source 112a, and the reflecting surface 114a reflects the light emitted from the light source 112a left-aslant-forward. The light emitted from the reflector 114 is projected so that it is appropriately diffused horizontally according to the free sectional shape of the reflecting surface 14a.

The projection lens 118 is a convex lens which is convex on the forward side of the vehicle and plane on the rearward side thereof. The center axis Lx of the projection lens 118 is in parallel to the vehicle longitudinal direction Vx. The projection lens 118 is fixed to the reflector 14 through a lens holder 119 at a position deviated outward of the vehicle (right side in FIG. 2) from the liner segment in parallel to the vehicle longitudinal direction Vx passing through the light source 112a.

The projection lens 118 is a lens which directly forward projects the light emitted from the light source 112a of the light source bulb 12 provided within the reflector 114. The projection lens 118, as seen from FIG. 2, is positioned so that its rear focal point P is located in the vicinity of the light source 112a of the light source bulb 112. The projection lens 118 forward projects, as substantially parallel rays of light, the light emitted from the light source bulb 112a and incident on the projection lens 118 through its rear focal point P. Namely, the light source 112a and projection lens 18 according to this embodiment constitute a projector type lamp not using a reflecting mirror.

Next, referring to FIG. 3, an explanation will be given of the optical path and distributed light pattern of the light emitted from the bending lamp 110 according to this embodiment.

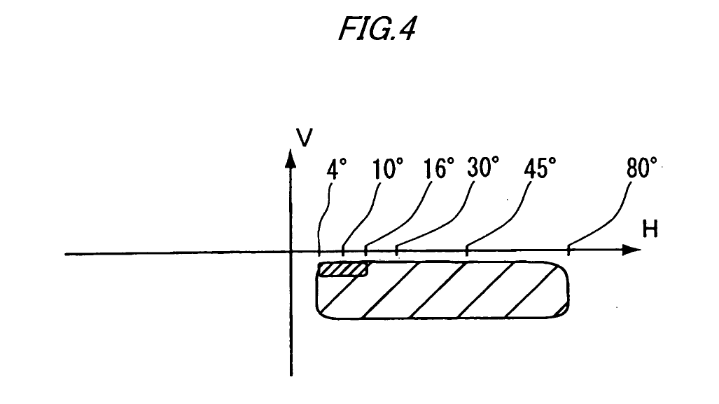

FIG. 3 is an optical path diagram of the light emitted from the bending lamp 110. FIG. 4 is a view showing the distributed light pattern of the light projected by the bending lamp 110.

The bending lamp 110 according to this embodiment projects the light emitted from the light source 112a outward of the vehicle through two kinds of optical paths roughly classified.

First, the first optical path is a pattern in which the light emitted from the light source 112a is directly incident on the projection lens 118 and projected forward. In FIG. 3, as indicated by solid line arrows, a part of the light emitted from the light source 112a is directly incident on the projection lens 118 through the vicinity of the rear focal point P of the projection lens 18 and projected forward as a group of light rays L1.

In this embodiment, since the light source 112a is located on the slightly left side of the lens central axis Lx of the projection lens 118, the light passed through the projection lens 118 is projected slightly rightward of the lens central axis Lx of the projection lens 118. The angle formed by the optical axis of the group of light rays L1 with a vehicle advancing direction in the horizontal plane is e.g. 10° to 20°. In this embodiment, the optical axis is oriented to 10°, and a distributed light pattern 130 with high light intensity converged within a range from about 4° to 16° as shown in FIG. 4 is created.

Next, the second optical path is a pattern in which the light emitted from the light source 112a is reflected by the reflecting surface 114a of the reflector 114 and projected forward. In FIG. 3, as indicated by broken line arrows, a part of the light emitted from the light source 112a is projected rearward and reflected by the reflecting surface 114a of the reflector 114. The light reflected by the reflecting surface 114a is projected right-aslant-forward of the vehicle as a group of light rays L2. The angle formed by the optical axis of the group of light rays L2 forward projected by the projection lens 118 with the vehicle advancing direction is larger than the angle formed by the optical path of the group of light rays L1 with the vehicle advancing direction in the horizontal plane. Namely, the group of light rays L2 illuminate the range more sideward than the group of light rays L1 do. In this embodiment, as seen from FIG. 4, a distributed light pattern 131 is created with the light diffused to some extent within a range from about 4° to 80°. The distributed light pattern 131 is projected superposedly on the distributed light pattern 130 to illuminate a sideward wide range inclusive of the distributed light pattern 130.

In summary, as seen from FIG. 4, in the bending lamp 110 according to this embodiment, as the distributed light pattern 130, the light with high light intensity is projected within a range from about 4° to 16°. As the distributed light pattern 131, the light is projected with a range from about 4° to 80°. The distributed light pattern 130 gives the projection angle effective to enhance the forward visibility by the bending lamp 110 while the vehicle runs at a medium speed (e.g. 20 km to 40 km) Therefore when the vehicle reduces the speed for cornering to some degree to light up the bending lamp 110, the forward visibility can be further assured. On the other hand, the distributed light pattern 131 gives the projecting angle effective to enhance the visibility of the bending lamp 110 while the vehicle runs at a low speed (e.g. 20 km or lower). Therefore even where the speed of the vehicle falls to a sufficiently low speed, when the bending lamp 110 lights up, the sideway visibility can be improved. In this way, the bending lamp 110 according to this invention is a lamp providing high visibility in a range from the low speed to the medium speed in which the bending lamp is frequently employed.

As understood from the description hitherto made, the bending lamp 110 according to this embodiment includes, within a lamp room 1‘d composed of a lamp body 103 and a cover 102, a light source bulb 112 equipped with a light source 12a for emitting light; a reflector 114 for reflecting light emitted from the light source 112a; and a projection lens 118 for directly forward projecting the light emitted from the light source. In this case, the reflector 114 projects the light emitted from the light source 112a directly outward of the vehicle. And the optical axis of the group of light rays L1 directly projected through the projection lens 118 and the optical axis of the group of light rays L2 projected through the reflector 114 are oriented in different directions.

In this way, in accordance with the bending lamp 110 according to this embodiment, the optical axis of the group of light rays L1 directly projected through the projection lens 118 and the optical axis of the group of light rays L2 projected through the reflector 114 are oriented in different directions so that light is projected over a wide angular range. Thus, the bending lamp 110 with high visibility in all of forward, aslant-forward and sideward directions can be provided.

Further, in the bending lamp 110 according to this embodiment, the angle formed by the optical axis of the group of light rays L1 directly projected through the projection lens 118 with the vehicle longitudinal direction is smaller than the angle formed by the optical axis of the group of light rays L2 projected via a reflector 114 with the vehicle longitudinal direction. Thus, since the two kinds of light rays L1, L2 are projected over different angular ranges, the bending lamp 110 with high visibility in all of forward, aslant-forward and sideward directions can be provided.

Further, in the bending lamp 110 according to this embodiment, the group of light rays L1 emitted from the light source 112a are directly projected through the projection lens 118. Therefore in the projector type lamp having a configuration in which the distance between the light source 112a and the projection lens 118 is short, intense spot-like light can be projected in a specific area. In this embodiment, the group of light rays L1 are projected in a direction over a range from 4° to 16° from the vehicle advancing direction. This direction gives the projecting angle effective to the visibility of the bending lamp 110 from forward when the vehicle runs at the medium speed (e.g. 20 to 40 km). Therefore when the vehicle reduces the speed for cornering to some degree to light up the bending lamp 110, the bending lamp 110 with the improved forward visibility can be provided.

Further, in the bending lamp 110 according to this embodiment, the light source bulb 112 is inserted from side in substantially parallel to the vehicle width direction. For this reason, without providing an attaching member for the light source bulb on the rear subjected to considerable limitation in size and protruding the end of the light source bulb 112, the bending lamp 110 with an elegant layout can be provided.

Further, although the bending lamp 110 according to this embodiment is a projector type lamp in which light is projected forward through the projection lens 118, the light emitted from the light source 112a is caused to be directly incident on the projection lens 118. For this reason, the reflector for causing light to be incident on the projection lens 118 is not required so that projector-type light projection can be done in a compact configuration.

Incidentally, in the above explanation, the distributed light pattern 131 is projected over the range from about 4° to 80°. However, without being limited to this, this distributed light pattern 131 may be appropriately projected so as to cover the distributed light pattern 30 so that light goes around a wide range.

Incidentally, in the above embodiment, the explanation was given of the example of the bending lamp attached to the forward right side. However, this invention may be applied to the bending lamp attached to the other area. Further, this invention may be applied to not only the bending lamp but also to other head lamps such as a cornering lamp and fog lamp.

<Second Exemplary Embodiment>

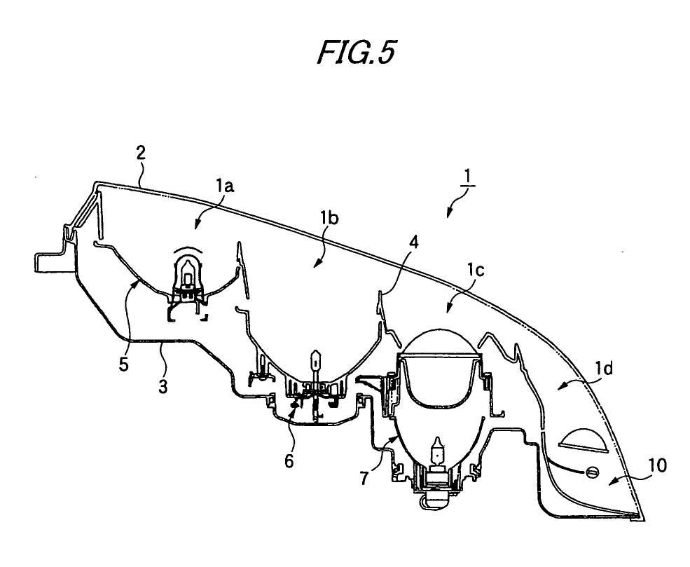

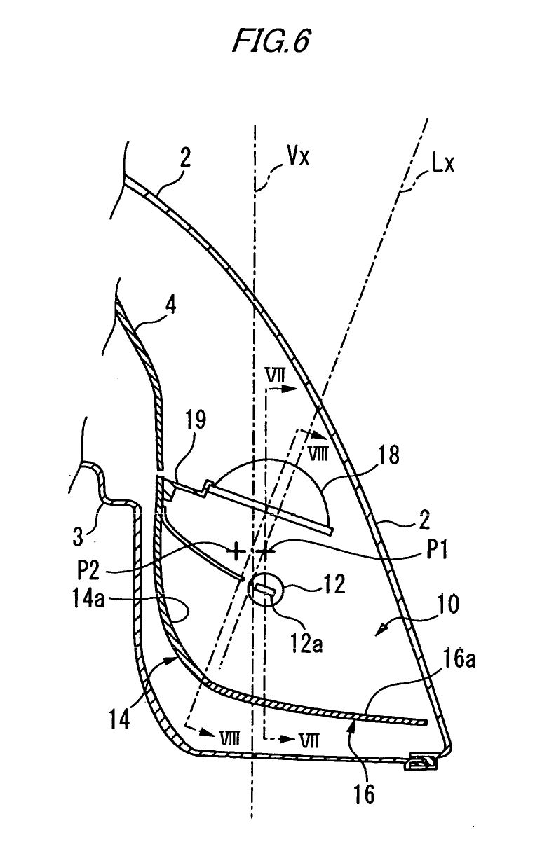

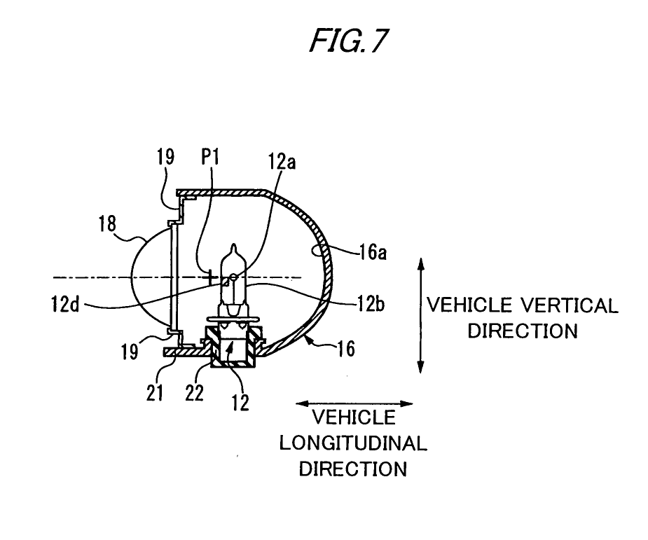

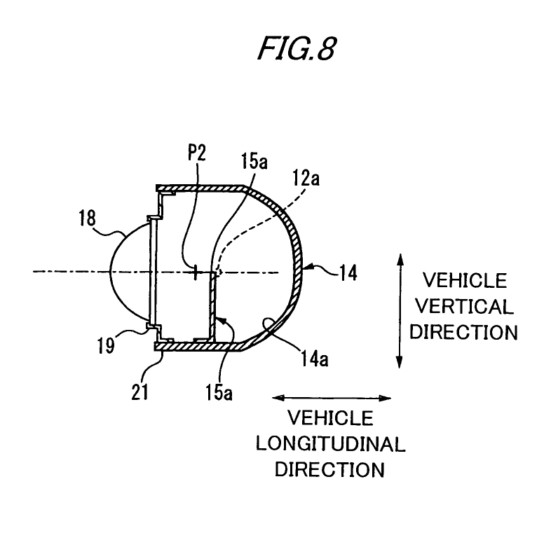

FIG. 5 is a horizontal sectional view of a lamp unit attached to the front right side of a vehicle. FIG. 6 is an enlarged horizontal sectional view showing the details of only a bending lamp portion of the lamp unit in FIG. 5. FIG. 7 is a sectional view taken in line VII-VII in FIG. 6. FIG. 8 is a sectional view taken in line VIII-VIII in FIG. 6.

As seen from FIG. 5, a lamp unit 1 according to this embodiment mainly includes a lamp body 3 and a light-permeable cover 2 covering the opening of the lamp body 3. The space between the lamp body 3 and the cover 2 is partitioned by extensions 4 to form four lamp rooms 1a, 1b, 1c and 1d. Each lamp room 1a, 1b, 1c, 1d incorporates a light source bulb, a reflector, etc to constitute a vehicle lamp.

In this embodiment, the lamp room la includes a fog lamp 5; the lamp room 1b includes a head lamp unit 6 for projecting a running beam (high beam); the lamp room 1c includes a head lamp unit 7 for projecting a “passing-each-other” beam (low beam); and the lamp room 1d includes a bending lamp 10.

A detailed explanation will be given of the bending lamp 10 provided in the lamp room 1d.

The bending lamp 10 is a head lamp which is attached to the forward right side of the vehicle and lights up at the time of turning right according to a driver's operation to illuminate a right-turning area, thereby assuring cornering visibility. The bending lamp 10, as seen from FIG. 6, includes a light source bulb 12; a first reflector 14 (first reflecting member) and a second reflector 16 (second reflecting member) arranged behind the light source bulb 12; a shade 15 located on the left side of the light source bulb 12; and a projection lens 18 located in front of the light source bulb 12.

The light source bulb 12 is a halogen bulb such as H3 which emits light from a light source 12a formed of a filament located within a bulb tube 12b as shown in FIG. 7. The light source bulb 12 is firmly inserted vehicle-vertically in a through-hole 22 which opens in an extension 21 extended out forward of the vehicle from the lower end of the second reflector 16. Thus, the light source bulb 12 is fixed so that the axial direction of the bulb tube 12b is substantially in parallel to the vertical direction of the vehicle and the light source 12a is located in the vicinity of P1 which is one point of a group of rear focal points of the projection lens 18. Incidentally, as seen from FIG. 6, the light source bulb 12 in this embodiment is attached so that the central axis of the filament corresponding to the light source 12a is in parallel to a horizontal plane.

Further, as seen from FIG. 7, on the bulb tube 12b of the light source bulb 12, a shielding member 12d, for shielding apart of the light emitted from the light source 12a is arranged. The shielding member 12d may be e.g. light-shielding applied film whose upper end is located on a line passing the light source 12a and one point P1 of the rear focal points of the projection lens 18 and in the vicinity of the point P1. The emitted light, a part of which is shielded by the shielding member 12d, is projected by the projection lens 18 to form a projected image having a cut-off line in front of the projection lens. The shape of the upper end of the shielding member 12d may be a shape corresponding to the shape of the cut-off line to be formed.

The first reflector 14 is a reflecting member attached so as to cover the left rear area from the left side of the light source 12 as seen from FIG. 6. The second reflector 16 is a reflecting member attached so as to cover the right rear area from the rear of the light source bulb 12. In FIG. 6, the first reflector 14 and the second reflector 16 are formed integrally, but may be formed as different bodies.

First, an explanation will be given of the first reflector 14 and optical members related therewith.

The first reflector 14 has a first reflecting surface 14a formed on its inner periphery, which has e.g. an elliptical shape in its vertical section and a free curved shape formed on the basis of the elliptical shape in its horizontal section as seen from FIGS. 6 and 8. The first focal point of the first reflecting surface 14a is substantially located at the light source 12a. The first reflecting surface 14a reflects the light emitted from the light source 12a toward the vicinity of a second focal point P2 located on the side the forward projection lens 18. In the first reflector 14, according to the horizontal sectional shape having the free curved sectional shape, the diffusion degree of the light reflected by the first reflector 14 is determined.

The shade 15 is a shade which is, as seen from FIG. 8, arranged between the first reflector 14 and the projection lens 18 and on the left side of the light source 12a so as to shield a part of the light emitted from the first reflector 14. When a part of the emitted light is shielded by the shade 15, the image having the cut-off line corresponding to the upper end face 15a of the shade 15 is formed in the vicinity of the second focal point P2.

The projection lens 18 is a convex lens which is convex on the forward side of the vehicle and plane on the rearward side thereof. The projection lens 18 is fixed to the end of the first reflector 14 through a lens holder 19 so that its rotation center axis Lx makes a certain angle in a horizontal plane with a vehicle longitudinal direction Vx. The angle formed by the rotation center axis Lx of the projection lens 18 with the vehicle longitudinal direction Vx may be e.g. 20°.

The projection lens 18 projects, forward of the vehicle, the light which has been reflected by the first reflector 14 and partially shielded by the shade 15. The image formed by the light reflected by the first reflector 14 and passed through the shade 15 is projected forward as an image 180° rotated and inverted by the projection lens 18.

Next, an explanation will be given of the second reflector 16.

The second reflector 16 has a second reflecting surface 16a formed on its inner periphery, which has e.g. a parabolic shape in its vertical section and a free curve formed on the basis of the parabolic shape in its horizontal section, as seen from FIGS. 6 and 7. The focal point of the second reflecting surface 16a is located substantially at the light source 12a. The first reflecting surface 16a reflects the light emitted from the light source 12a sideward from right-forward. The projection range of the second reflecting surface 16a is defined by the horizontal sectional shape having the above free curve.

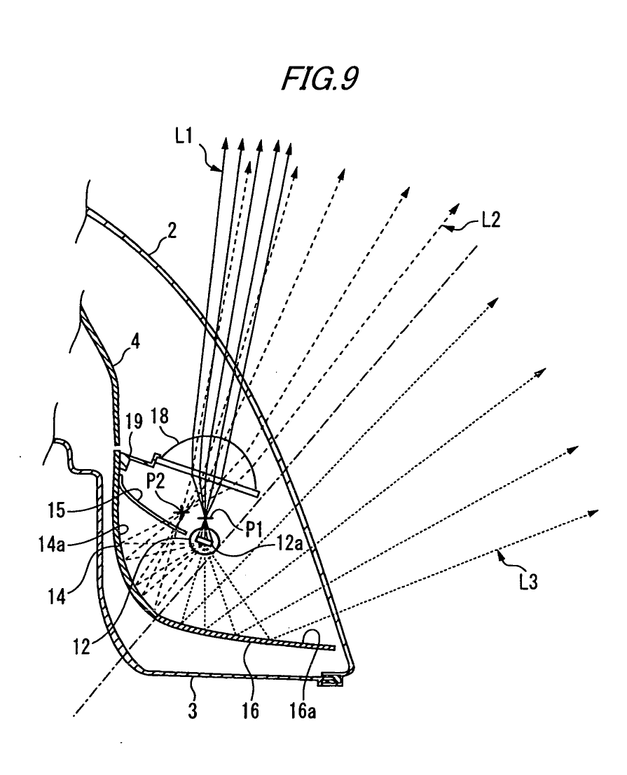

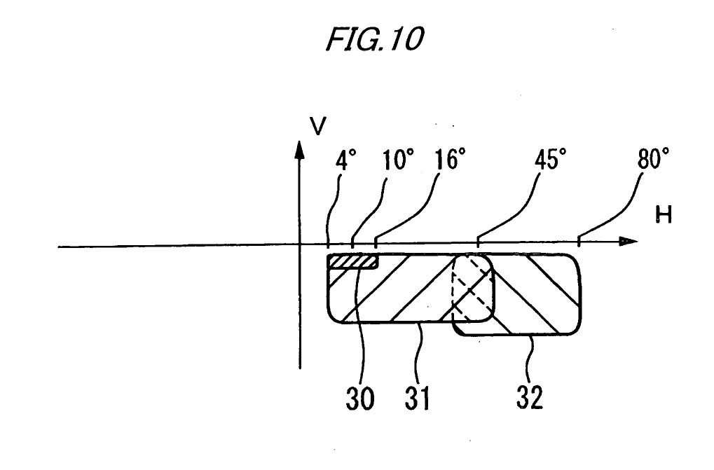

Now referring to FIGS. 9 and 10, an explanation will be given of a distributed light pattern formed by the light emitted from the bending lamp 10.

FIG. 9 is an optical path diagram of the light emitted from the bending lamp 10 according to this embodiment. FIG. 10 is a view showing the distributed light pattern of the light projected by the bending lamp 10.

The bending lamp 10 according to this embodiment projects the light emitted from the light source 12a through three kinds of optical paths, roughly classified, outside the vehicle.

First, the first optical path is a pattern in which the light emitted from the light source 12a is directly incident on the projection lens 18 and projected forward. In FIG. 9, as indicated by solid line arrows, a part of the light emitted from the light source 12a is directly incident on the projection lens 18 through the vicinity of the one point P1 of a group of rear focal points of the projection lens 18 and projected forward as a group of light rays L1. The projecting direction of the group of light rays L1 is determined by the positional relationship between the projection lens 18 and the light source 12a.

In this embodiment, since the light source 12a is located on the slightly right side of the rotation central axis Vx, the light passed through the projection lens 18 is projected slightly left ward of the rotation center axis Vx of the projection lens 18. The angle formed by the optical axis of the group of light rays L1 with a vehicle advancing direction in the horizontal plane is e.g. 10° to 20°. In this embodiment, the optical axis is oriented to 10°, and a distributed light pattern 30 converged within a range from about 4° to 16° as shown in FIG. 10 is created. The upper end of the distributed light pattern 30 constitutes a cut-off line in which clearly cuts a bright/dark area by means of the shielding member 12d.

Next, the second optical path is a pattern in which the light emitted from the light source 12a is reflected by the first reflecting surface 14a of the first reflector 14 and projected forward through the shade 15 and projection lens 18. In FIG. 9, as indicated by rough broken line arrows, a part of the light emitted from the light source 12a is projected left-rearward and reflected by the first reflecting surface 14a of the first reflector 14. The light reflected by the first reflecting surface 14a advances toward the shade 15. A part of the light is shielded by the shade 15. The light thus created is focused in the vicinity of the second focal point P2. The group of rear focal points of the projection lens 18 is located in the vicinity of the second focal point P2.

And the light focused at the second focal point P2 of the projection lens l8, i.e. the rear focal point of the projection lens 18 is incident on the projection lens 18 and projected forward as a group of light rays L2 in a state converged to some degree. The angle formed by the optical axis of the light rays L2 projected forward by the projection lens 18 with the vehicle advancing direction is larger than that formed by the optical axis of the light rays L1 with the vehicle advancing direction in the horizontal plane. Namely, the group of light rays L2 illuminate the range more sideward than the group of light rays L1 do. In this embodiment, as seen from FIG. 10, a distributed light pattern 31 is created with the light diffused to some extent within a range from about 4° to 45°. The distributed light pattern 31 is projected superposedly on the distributed light pattern 30 to illuminate a sideward wide range inclusive of the distributed light pattern 30.

Next, the third optical path is a pattern in which the light emitted from the light source 12a is reflected by the second reflecting surface 16a of the second reflector 16 and projected forward as it is. In FIG. 9, as indicated by fine broken line arrows, a part of the light emitted from the light source 12a is projected rearward, reflected by the second reflecting surface 16a, and projected forward. The angle formed by the optical axis of a group of light rays L3 forward projected by the projection lens 18 with the vehicle advancing direction is larger than the angle formed by the optical axis of the group of light rays L1 with the vehicle advancing direction in the horizontal plane and the angle formed by the optical axis of the group of light rays L2 with the vehicle advancing direction. Namely, the group of light rays L3 illuminate the range more sideward than the group of light rays L2 do. In this embodiment, as seen from FIG. 10, a distributed light pattern 32 is created with the light diffused to some extent within a range from about 45° to 80°. The distributed light pattern 32 is partially projected superposedly on the distributed light pattern 31 to illuminate a more sideward wide range inclusive of the distributed light pattern 31.

As described above, the bending lamp 10 according to this embodiment includes, within a lamp room 1d composed of a lamp body 3 and a cover 2, a light source bulb 12 equipped with a light source 12a for emitting light; a first and a second reflector 14, 16 for reflecting light emitted from the light source 12a; a shade 15 for shielding a part of the light reflected by the first reflector 14, and a projection lens 18 for directly forward projecting the light emitted from the light source 18. In this case, the first reflector 14 causes the light emitted from the light source 12a to be incident on the projection lens 18 through the shade 15 and forward projects the incident light. The second reflector 16 directly sideward projects the light emitted from the light source 12a.

The optical axis of the group of light rays L1 directly projected through the projection lens 18, the optical axis of the group of light rays L2 projected through the first reflector 14 and the optical axis of the group of light rays L3 projected through the second reflector 16 are different from one another.

In this way, in accordance with the bending lamp 10 according to this embodiment, since the optical axis (first optical axis) of the group of light rays L1 directly projected through the projection lens 18, the optical axis (second optical axis) of the group of light rays L2 projected through the first reflector 14 and the optical axis (third optical axis) of the group of light rays L3 projected through the second reflector 16 are different from one another, the light is projected over a wide angular range. Thus, the bending lamp 10 with high visibility in all of forward, aslant-forward and sideward directions can be provided.

Concretely, in the bending lamp 10 according to this embodiment, the angle formed by the optical axis of the group of light rays L1 directly projected by the projection lens 18 with the vehicle longitudinal direction is smaller than the angle formed by the optical axis of the group of light rays L2 projected through the first reflector 14 with the vehicle longitudinal direction. And the angle formed by the optical axis of the group of light rays L2 projected through the first reflector 14 with the vehicle longitudinal direction is smaller than the angle formed by the group of light rays L3 projected through the second reflector 16 with the vehicle longitudinal direction. Thus, since the three kinds of groups of light rays L1 to L3 are projected in different angular directions from one another, the bending lamp 10 with high visibility in all of forward, aslant-forward and sideward directions can be provided.

Further, in the bending lamp 10 according to this embodiment, the group of light rays L1 are emitted from the light source 12a and directly projected through the projection lens 18. Therefore in the projector type illuminating device having a configuration in which the distance between the light source 12a and the projection lens 18 is short, intense spot-like light can be projected in a specific area. In this embodiment, the group of light rays L1 are projected in the direction of the angle of 4° to 16° from the vehicle advancing direction. This angle is a projecting angle effective to enhance the visibility of the forward bending lamp 10 when the vehicle runs at a medium speed (e.g. 20 to 40 km). Thus, there can be provided the bending lamp 10 which can be easily visually recognized by the third person in front when the speed of the vehicle is reduced for cornering and the bending lamp 10 is lit.

Further, in the bending lamp 10 according to this embodiment, the light source bulb 12 is arranged upward from below substantially in parallel to the vehicle vertical direction. For this reason, it does not occur that an attaching member for the light source bulb is provided on the side or rear subjected to considerable limitation in size and the end of the light source bulb is protruded. Thus, the bending lamp 10 with an elegant layout can be provided.

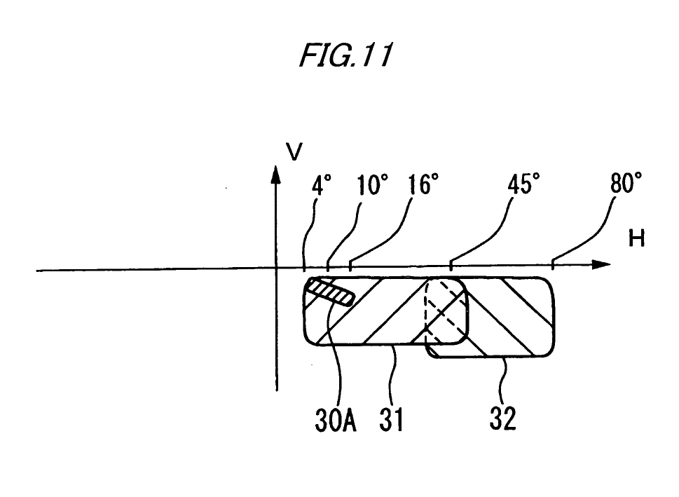

Incidentally, in this embodiment, the filament constituting the light source 12a of the light source bulb 12 was attached so that its central axis is in parallel to the horizontal plane. However, without being limited to such a layout, the filament may be attached so that its central axis forms a certain angle with the horizontal plane. FIG. 11 shows a distributed light pattern when the filament is attached so that its central axis forms a certain angle with the horizontal plane. In FIG. 11, a distributed light pattern 30A formed by the group of light rays L1 tilts so that it slopes aslant sideward from the vehicle longitudinal direction. In this way, by constructing the tilted distributed light pattern 30A, the visibility of a road surface within a range from the medium speed to low speed can be enhanced.

Incidentally, in the above embodiment, the explanation was given of the example of the bending lamp attached to the forward right side. However, this invention may be applied to the bending lamp attached to the other area. Further, this invention may be applied to not only the bending lamp but also the other head lamp such as a stop lamp.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A vehicle lamp comprising:
a bulb including a light source for emitting light;
a reflector that reflects the light emitted from the light source, wherein the light is reflected on the reflector toward an outside of a lamp room; and
a projection lens that forward projects the light emitted directly from the light source, wherein an optical axis of the light projected through the projection lens is oriented in a different direction from an optical axis of the light projected through the reflector.

2. The vehicle lamp according to claim 1, wherein the bulb is arranged along a vehicle width direction.

3. The vehicle lamp according to claim 1, wherein an angle between the optical axis of the light projected through the projection lens and a vehicle longitudinal direction is in a range from 10° to 20°.

4. The vehicle lamp according to claim 1, wherein the light reflected through the reflector comprises diffused light diffused by an angle of 4° to 80° from a vehicle longitudinal direction.

5. A vehicle lamp comprising:
a bulb including a light source for emitting light;
a reflector that reflects the light emitted from the light source; and
a projection lens that forward projects the light,
wherein the reflector includes:
a first reflecting member, wherein the light emitted from the light source is reflected on the first reflecting member toward the projection lens; and
a second reflecting member, wherein the light emitted from the light source is reflected on the second reflecting member directly toward a sideward direction without being incident to the projection lens, and
first, second and third optical axes are different from one another, wherein the first optical axis is an optical axis of the light being directly incident to the projection lens from the light source and projected through the projection lens, the second optical axis is an optical axis of the light from first reflecting member and projected through the projection lens, and the third optical axis is an optical axis of the light reflected on the second reflecting member.

6. The vehicle lamp according to claim 5, further comprising:
a shade arranged in a vicinity of a rear focal point of the projection lens, for shielding a part of the light reflected by the reflector; and
a shielding member arranged on the light source bulb, for shielding a part of the light emitted from the light source.

7. The vehicle lamp according to claim 6, wherein the shade shields a part of the light reflected by the first reflecting member so as to form a cut-off line.

8. The vehicle lamp according to claim 5, wherein the light source bulb is arranged substantially in parallel to a vehicle vertical direction.

9. The vehicle lamp according to claim 5, wherein an angle between the first optical axis and a vehicle longitudinal direction is smaller than an angle between the second optical axis and the vehicle longitudinal direction, and smaller than an angle between the third optical axis and the vehicle longitudinal direction.

10. The vehicle lamp according to claim 5, wherein an angle between the first optical axis and a vehicle longitudinal direction is in a range from 10° to 20.
